(19) United States
(12) Patent Application Publication
(10) Pub. No.: US 2022/0189214 A1
(43) Pub. Date: Jun. 16, 2022

(54) MODULE FOR COLLECTING DATA RELATING TO A DEVICE OF A VEHICLE

(71) Applicant: Faiveley Transport Tours, Saint-Pierre-des-Corps (FR)

(72) Inventors: Saber Bayoudh, Tours (FR); Fabrice Lamide, Montlouis sur Loire (FR)

(21) Appl. No.: 17/436,452

(22) PCT Filed: Mar. 3, 2020
(86) PCT No.: PCT/FR2020/050419

§ 371 Date: Sep. 3, 2021

(30) Foreign Application Priority Data
Mar. 4, 2019 (FR) 1902194

(51) Int. Cl. G07C 5/00; G07C 5/08

(52) U.S. Cl. CPC G07C 5/008; G07C 5/0816; G07C 5/006

(57) ABSTRACT

A data collection module for collecting data relating to at least one device of a vehicle is provided. The module includes connection means configured to be connected to a maintenance port of a device controller that manages operation of the at least one device. The connection means also is configured to establish communication with the device controller through the maintenance port. The module also includes data retrieval means configured to collect, during the operation of the at least one device at predefined instants, data relating to the at least one device via the communication that is established.

### CROSS-REFERENCE TO RELATED APPLICATIONS

This application is a national stage entry of and claims priority to International Patent Application No. PCT/FR2020/050419 (filed 3 Mar. 2020), which claims priority to French patent application 1902194 (filed 4 Mar. 2019). The entire disclosures of these applications are incorporated herein by reference.

### BACKGROUND

### Technical Field

The present invention concerns a data collection module for collecting data relating to at least one device of a passenger transport vehicle. It furthermore concerns a system and a method for processing those data. The invention also applies in particular to vehicles for rail transport for example such as trains, subways, tramways, trolleybuses, etc.

### State of the Art

Passenger transport vehicles such as rail transport vehicles comprise numerous devices provided in particular for the operation of the vehicle and for the comfort of the passengers. For example, the devices may be the braking system, the unit for air generation and treatment, the system for opening/closing the doors, the air conditioning system, etc. In this document, by “devices” is meant one or more devices present in the rail transport vehicle.

In general, each device is associated with a device controller which is provided to control its operation. Sometimes, the controller forms part of the device. In certain cases, a single device controller can manage the operation of several devices.

In current rail transport vehicles, the various devices, in particular the device controllers, communicate with an on-board computer by means of a network. The current devices are so-called “smart” electronic devices, managed by one or more microprocessors. The on-board computer is known as a TCMS (for “Train Control and Monitoring System”). The on-board computer is provided to communicate with device controllers in the vehicle in order to manage the operation of the devices on board the vehicle and to monitor whether they are operating correctly.

The networks equipping rail transport vehicles for the communication of the devices and the on-board computer, make it possible to exchange data in different amounts depending on the construction date of the train.

Although the capacity for exchange by these networks has improved with time, in certain old trains, the exchange for data between the devices and the on-board computer, and therefore the functionalities of the on-board computer using the data relating to the devices, is still rather limited.

To increase the quality of information gathered in relatively old rail transport vehicles, it is known to install new generation wired networks, such as the Ethernet network, having better performance than the old networks.

Nevertheless, this solution is very intrusive when it requires the removal of partitions and trimming required for running cables throughout the length of the vehicle. Furthermore, the controllers for the devices as well as the on-board computer become obsolete and must be replaced in order to be able to be used by the new generation networks. Therefore, this type of solution is very costly. Furthermore, other components involved in the communication between devices, for example such as the coupler that enables the transmission of wired signals between wagons, must be replaced, which can significantly increase the overall cost.

Another solution, less costly and widely used today, consists of installing sensors, for example wireless sensors, at points of the vehicle that are suitable for acquiring information relating to the devices. This information may for example be the temperature in the passenger compartment or the open or closed position of the doors. Nevertheless, such a solution makes it possible to collect a limited amount of information dependent on the number of sensors installed in the rail transport vehicle. Furthermore, the reliability of the rail transport vehicle becomes is affected by the addition of the sensors, these sensors being active components liable to fail. Furthermore, this solution does not make it possible to take advantage of the functionalities of the device controllers whereas they already have access to information relating to the devices to ensure their proper operation. For example, the air conditioning controller knows the temperature in the vehicle, and the door controller knows the position of the door. Therefore, the addition of such sensors is redundant from the point of view of obtaining the information.

### BRIEF SUMMARY

The present invention is directed to providing a data collection module for collecting data relating to at least one device of a passenger transport vehicle, making it possible to obtain, by itself, a high amount of data, and without however altering the device installed in the vehicle.

To that end, according to a first aspect, the present invention concerns a data collection module for collecting data relating to at least one device of a passenger transport vehicle.

According to the invention, the data collection module comprises:
connection means configured to be connected to the maintenance port of a device controller managing the operation of said at least one device and to establish communication with the device controller through the maintenance port; and
data retrieval means configured to collect, during the operation of said at least one device at predefined instants, data relating to said at least one device via the established communication.

The collection module can thus retrieve, through the maintenance port of a device controller, data relating to the device itself without requiring installation of additional components, such as sensors.

The collection of data is performed at predefined instants enabling data to be collected progressively with operation of said at least one device.

A collection module having the features specified below may be installed in a rail transport vehicle, simply by connecting to the maintenance port of a device controller and without having to alter the devices, device controllers and networks already installed in the vehicle.

The installation of the collection module in the rail transport vehicle thus makes it possible to obtain a high amount of data without modifying the device carried on board the vehicle, whatever its generation.

According to a feature, the data retrieval means are configured to emit commands for reading data relating to said at least one device.

The data reading commands are emitted once a communication has been established between the data collection module and the device controller.

For example, the communication between the data collection module and the device controller is a serial type communication.

According to a feature, the data collection module further comprises checking means configured for checking the authenticity of the reading commands.

The presence of checking means provides security for the communication between the data collection module and the device controller, and for obtaining data relating to the device.

For example, a table of authorized commands is implanted in the data collection module at the time of the production phase and makes it possible to check the validity of the requests sent to the device controller. Furthermore, the data collection module verifies the frequency of exchanges with the device controller and blocks any request inconsistent with that frequency.

According to one embodiment, the checking means comprise a programmable component, for example of FPGA type.

According to a feature, the data collection module (and in particular the retrieval means) is configured to enable the communication between the data collection module and the device controller, and to collect the data relating to the device. For example, a microprocessor employs a software application comprising a sequence of instructions enabling the communication between the data collection module and the electrical device and the collection of the data relating to the device.

Thus, the data collection module may be configured to adapt itself in a manner specific to device controllers operating differently and may thus exchange data with the device controller to which it is connected. Therefore, the collection module may be modified and configured according to the device from which it will collect data, or in other words according to the device controller with which it will exchange information.

In particular, the data relating to said at least one device may comprise parameters for input to or for output from said device controller and/or parameters determined by said device controller and/or fault statuses determined by said device controller.

Obtaining parameters for input to and for output from the device controller makes it possible in real time to know the status of the device and the actions of the device controller, that is to say the commands sent to the different components of the device. These data make it possible to check that the device is operating correctly.

The parameters determined by the device controller, which are functional parameters of the device or of the rail transport vehicle, may also be retrieved. These data may be used in order to perform deep analysis of the behavior of the device and of the rail transport vehicle in real time.

Furthermore, the data collection module uses the self-diagnostic capacities of the device controller since it also collects the faults detected by the device controller, these data making it possible to know fault statuses in real time during the operation of the device.

Therefore, the data obtained by the collection module, in addition to being high in quantity, are also high in quality since they enable very full information to be obtained on the operation of the device in real time. This information could be exploited later to monitor the operation of the devices and to plan maintenance operations rapidly.

According to a feature, the data collection module comprises transmission means configured to transmit the data collected to a data concentrator module.

The transmission of the data to a data concentrator enables global processing of the data coming from different collection modules, uniformization and facilitation of the data processing thus being provided.

According to a second aspect, the present invention concerns a system for processing data relating to a set of a passenger transport vehicle devices, comprising a set of data collection modules in accordance with the invention. Each data collection module is associated with a device controller managing the operation of at least one device of the set of devices.

A data processing system may thus comprise collection modules associated respectively with device controllers, the device controllers being able to manage the operation of a single device or of several devices.

According to a feature, the data collection system further comprises a data concentrator module configured to receive data coming from the data collection modules of the set of modules.

The concentrator module thus groups together the data relating to several devices.

According to a feature, the data concentrator module is configured to store and transmit data to a server on the ground.

Thus, the server on the ground receives the data relating to the devices, in real time during their operation. These data may be analyzed so as to monitor that the devices are operating correctly and to prepare maintenance operations. For example, maintenance operations may be prepared in advance of the arrival at a station of the vehicle carrying a malfunctioning device.

According to a third aspect, the present invention concerns a passenger transport vehicle comprising a data processing system in accordance with the invention. The passenger transport vehicle is for example a rail transport vehicle.

According to a fourth aspect, the present invention concerns a method of processing data relating to at least one device on board a passenger transport vehicle, comprising the following steps:
establishing communication between a collection module for collecting data relating to said at least one device and a device controller managing the operation of said at least one device, the communication being established through the maintenance port of the device controller; and
retrieving data relating to said at least one device during the operation of the device at predefined instants, via the established communication.

According to a feature, the processing method further comprises:
a step of emitting a command for reading data relating to said at least one device, and
a step of checking the emitted reading command to check whether it is authorized, the retrieval step being implemented if at the checking step, the reading command is authorized.

According to a feature, the processing method further comprises a transmitting step for transmitting the data collected during the retrieval step, to a data concentrator module.

According to a feature, the processing method further comprises a step of forwarding the data received from the data concentrator module to a server on the ground.

The data processing system, the rail transport vehicle and the data processing method have features and advantages similar to those described previously in relation to the data collection module.

Still other particularities and advantages of the invention will appear in the following description.

### SUMMARY OF THE DRAWINGS

In the accompanying drawings, given by way of non-limiting example:

FIG. 1 is a diagram representing a data processing system in accordance with one embodiment of the invention;

FIG. 2 is a diagram representing a data collection mode in accordance with an embodiment of the invention linked to a device; and

FIG. 3 illustrates steps for a data processing method in accordance with one embodiment of the invention.

### DETAILED DESCRIPTION

The invention finds an application in the field of passenger transport vehicles, in particular in rail transport vehicles, whether they be dedicated to traveling long distances or short distances, such as vehicles for urban rail transport, for example such as subways and tramways.

In particular, the invention applies to any type of passenger transport vehicle having so-called “smart” devices, that is to say devices of which the operation is managed by an electronic device controller.

In general, in the case of rail transport vehicles, each wagon of the vehicle is equipped with several device controllers managing the operation of the devices present in the wagon, such as the brake systems, the door control systems, the air conditioning system, etc.

In some rail transport vehicles, a device controller is associated with a single device to manage its operation.

In other types of rail transport vehicle, several device controllers manage the operation of a device. In this case, there is in general a master device controller which controls the operation of the slave device controllers managing the operation of the device and together gathering data relating to that device.

In other types of rail transport vehicle, a same device controller may manage the operation of several devices, it being possible for the devices to be of the same type or of different type.

Thus, depending on the configurations, each device is associated with at least one device controller provided for the management of the operation of that device.

By way of example that is in no way limiting, in a wagon, there may be installed an air-conditioning controller, a brake controller, a controller for display devices such as screens, a controller for a passenger counting system, a controller for sanitary installations, etc. For example, each door of a same wagon is controlled by a device controller, a master door controller crystallizing the operation of the various door controllers.

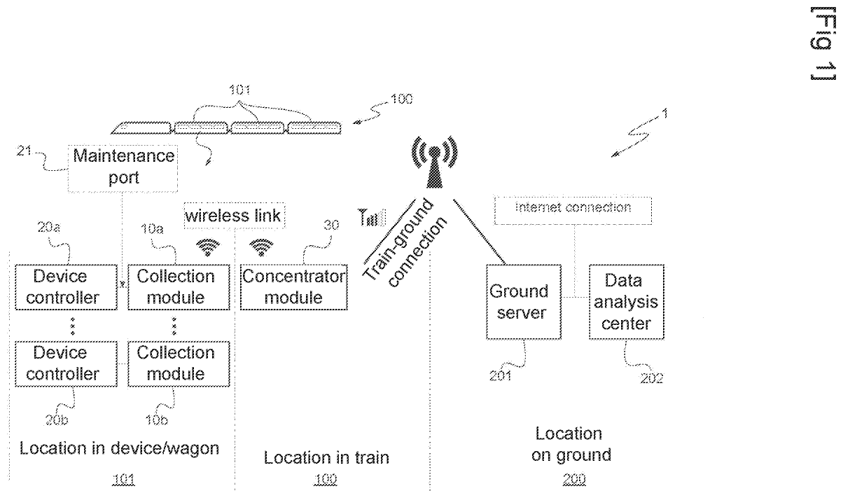

FIG. 1 shows a system for processing data relating to a set of devices of a passenger transport vehicle 100 in accordance with one embodiment of the invention. In the embodiment described, the passenger transport vehicle is a rail transport vehicle. Nevertheless, as indicated above, the invention applies to other types of passenger transport vehicles.

The embodiment represented by this Figure, comprises a first part carried on board in a rail transport vehicle 100 and a second part located on the ground 200.

According to other embodiments not shown, the data processing system is carried on board the rail transport vehicle in its entirety.

The part of the data processing system 1 carried on board the rail transport vehicle 100 comprises a set of data collection modules 10a, 10b (also referenced 10 in the interest of simplicity).

The data collection modules 10 are distributed between the wagons 101 of the rail transport vehicle 100.

According to an embodiment such as that shown in FIG. 1, each data collection module 10 is associated with a device controller 20a, 20b (also referenced 20 in the interest of simplicity) managing the operation of at least one device (not illustrated) of the rail transport vehicle 100.

FIG. 1 represents two data collection modules 10a, 10b, respectively associated with two device controllers 20a, 20b. Of course, as indicated above, the number of data collection modules and of device controllers in a wagon of the rail transport vehicle may be different.

To simplify the description, it is considered that a device controller 20 manages the operation of a single device.

Of course, as indicated above, a same device controller may manage the operation of several devices or several device controllers may manage the operation of a single device.

To simplify FIG. 1, data collection modules 10 and device controllers 20 present in a single wagon are shown. It will be noted that the type and the number of collection modules 10 and of device controllers may be equal or different for each wagon 101 of the rail transport vehicle 100. Furthermore, in the embodiment shown, a device controller 20 is associated with a data collection module.

The data collection system 1 may furthermore comprise several computer servers 201 on the ground 200 (also named server on the ground 201) at different geographical positions.

The computer servers on the ground 201 may communicate through a communication network, such as the internet, with a data analysis center 202.

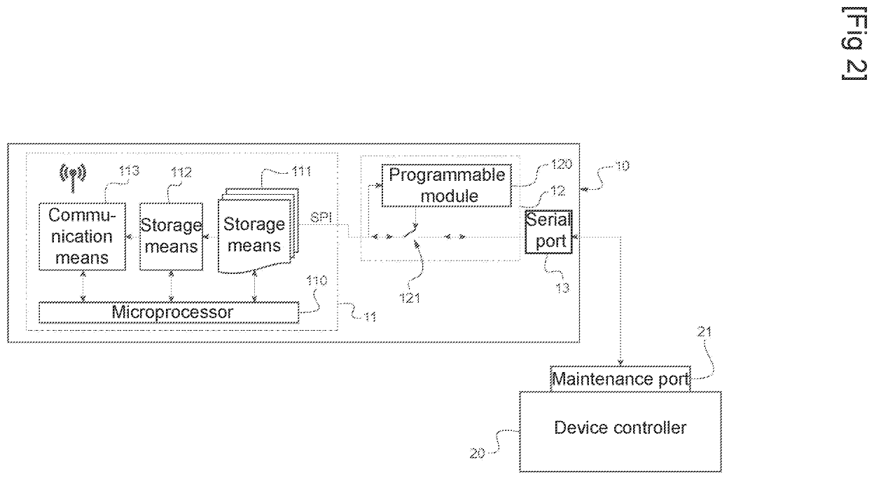

A data collection module 10 according to one embodiment is shown in FIG. 2 and will be described in detail below.

As will later be described with reference to FIG. 2, the data collection module 10 is connected to the device controller 20 at the maintenance port 21.

Through a connection implemented between the data collection module 10 and the associated device controller 20, the data collection module 10 collects data relating to the device managed by the device controller 20.

The data relating to the device may comprise parameters for input to and/or output from the device controller 20, determined by the device controller 20 and/or fault statuses terminated by the device controller 20.

The parameters for input to or output from the device controller 20 for example correspond to commands sent to the different components of the controlled device. Obtaining this type of parameter enables the evaluation of the status of the device and the checking that the device is operating correctly. Furthermore, the device controller 20 may determine parameters such as functional parameters of the device or of the rail transport vehicle 100. Lastly, the device controller 20 may in general perform a diagnostic when the electronic device has a fault status.

The collected data may be used in order to perform deep analysis of the behavior of the device and/or of the rail transport vehicle 100.

Thus, a high amount of data relating to the device is obtained by the data collection module 10, this being in real time, while the device operates. These data may be used to check that the devices are operating correctly at any time and to detect possible malfunctions in real time. Maintenance operations may thus be planned rapidly and optimally.

In one embodiment such as that shown, the data collection system comprises a data concentrator module 30 which is configured to receive data coming from the data collection modules 10.

In the embodiment shown a single data concentrator module 30 collects the data coming from the set of data collection modules 10 carried on board the rail transport vehicle 100.

In other embodiments, the data collection system comprises several data concentrator modules, each data concentrator module receiving data coming from a group of data collection modules.

According to one embodiment, the data concentrator module 30 comprises storage or memory means configured for storing the data received from the data collection modules 10.

Thus, the data concentrator module 30 can store data relating to some or all of the devices on board the rail transport vehicle 100.

In data collection systems comprising several data concentrator modules, each data concentrator module stores data relating to some of the devices. For example, a data concentrator module may be associated with devices of a particular type.

The data concentrator module 30 comprises control means managing its operation. In some embodiments, the data concentrator module is configured for the local processing of data coming from data collection modules 10.

According to one embodiment, the data collection module 10 as well as the data concentrator module 30 comprise communication means, such as wireless communication means, configured for communication between them.

By means of this communication implemented between the data collection modules 10 and the data concentrator modules 30, the data collection modules 10 send the collected data relating to the device of which the device controller 20 manages the operation.

The data collection module 10 and the data concentrator module 30 may connect via wireless communication means to a private wireless communication network (not shown) in the vehicle 100.

For example, these wireless communication means comprise, in known manner, interfaces configured to implement short-range radio links, for example established on the basis of WiFi technology, via “Bluetooth” (registered trademark) technology or other technology.

In other less advantageous embodiments, the connection between the collection modules and the data concentrator module is a wireless connection. In other words, the communication means of the module and of the data concentrator module may comprise wired communication means.

The data concentrator module 30 may in addition comprise transmission means configured to transmit data to a server on the ground 201, such as the data from the data collection modules 10.

In one embodiment, the data relating to the devices received by the data concentrator module 30 are sent regularly to the server on the ground 201. In case of interruption in the train-ground connection on transmission of the data, for example due to poor coverage by the network implementing the train-ground connection, the data are stored in the data concentrator module 30 and sent to the server on the ground 201 later.

The transmission means of the data concentrator module 30 comprise means for wireless transmission which may be configured for short-range communications or long-range communications.

In the embodiment shown in FIG. 1, the data concentrator module 30 is configured to establish connections with a distinct computer server 201 via a communication network.

The wireless communication means of the data concentrator module 30 can establish a connection with the server on the ground 101, and send it data, by means of a mobile telephone communication network operating for example in accordance with the 3G or 4G standards or by using a provide WiFi network.

The wireless communication means of the data concentrator module 30 may also send data to the server on the ground 201 via a communication network such as the internet to which they are connected by the short-range connection means such as a WiFi connection.

The data concentrator module 30 may also comprise wired communication means able to establish a wireless connection with the server on the ground, for example when it is located in a station.

The short-range wireless communication means may also be used when for example the electric transport vehicle is located at the depot where the server on the ground 201 is installed.

The presence of a data concentrator module 30 in the rail transport vehicle 100 makes it possible to limit the number of connections between the rail transport vehicle 100 and the ground 200 for the sending of the data relating to the devices in the vehicle 100. Furthermore, the data concentrator module 30 makes it possible to send these data in a coordinated manner.

The reduction in the number of train-ground connections makes it possible to reduce the costs linked to the subscriptions to the various communication networks.

Furthermore, the overall power of the system is reduced on account of the reduction in the number of connections between the rail transport vehicle 100 and the server on the ground 201.

FIG. 2 shows a data collection module 10 in in accordance with an embodiment of the invention, connected to a device controller 20.

As indicated above, the device controller 20 manages the operation of at least one device present in the rail transport vehicle 100.

The data collection module 10 comprises connection means 13 which are configured to be connected to the maintenance port 21 of the device controller 20. In one embodiment, the connection means 13 comprise a serial port.

The connection means 13 are furthermore configured to establish communication with the device controller 20 once the data collection module 10 and the device controller 20 have been connected through the maintenance port 21.

According to one embodiment, the communication between the data collection module 10 and the device controller 20 is a serial communication implemented through the serial port 13 of the data collection module 10.

The data collection module 10 further comprises data retrieval means 11 configured to collect data relating to the device of which the operation is managed by the device controller 20.

The data retrieval means 11 are configured to collect data during the operation of the device, at predefined instants.

In one embodiment such as that shown, the retrieval means 11 comprise a microprocessor 110 configured to implement the communication between the data collection module 10 and the device controller 20. For example, the microprocessor 110 implements onboard software in the data collection module 10 which implements the communication between the data collection module 10 and the device controller 20, and the collection of the data relating to the device.

The onboard software is thus configured for implementing communication between these two components using the communication protocol specific to them.

Furthermore, according to the device and the device controller 20, the software is configured for selecting parameters relating to that device, at the specific memory addresses where the parameters to retrieve are located.

Therefore, by virtue of this onboard software, the data collection module 10 adapts to communicate with different device controllers and to retrieve data for different electronic devices. This type of onboard software thus adapts to different communication protocols and to different devices that are known to the person skilled in the art and do not need to be described in detail.

The software may be loaded into the data collection module 10 at the time of its manufacture or on installation of the data processing system in the rail transport vehicle 100. The software is specific to the communication between the data collection module 10 and the device controller 20. It will be noted that each device controller 20 has a specific operation according to the device of which it manages the operation.

The software may be loaded for example in storage means 111 such as a non-volatile memory, for example ROM (for “Read Only Memory”), EEPROM (for “Electrically Erasable Read Only Memory”) or a Flash memory.

By virtue of the software in the data collection module 10, the data retrieval means 11 are configured to emit commands for reading the data relating to the device. The device controller 20 responds to these reading commands by sending the parameters requested in the reading commands, and which are stored in memory.

The data retrieval means 11 further comprise second memory or storage means 112, in which the data received from the device controller 20 are stored.

The second storage means 112 may for example comprise a volatile memory or RAM (for “Random Access Memory”). The volatile memory comprises registers configured for the recording, in addition to the collected data, of the variables and parameters created and modified during the execution of a computer program comprising instructions for the implementation of a method according to the invention. The codes of instructions of the program stored in non-volatile memory are loaded into RAM memory for the purpose of being executed by the microprocessor 110.

The non-volatile memory is for example a re-writable memory of EEPROM type or Flash memory able to constitute a medium according to the meaning of the invention, that is to say able to comprise the software are computer program comprising instructions for the implementation of the method according to the invention, the software having been configured beforehand for the type of device controller.

The different components of the data collection module 10 are connected to a communication bus (not shown) enabling the exchange of data between them.

In one embodiment, the data collection module 10 further comprises checking means 12 configured to check the authenticity of the reading commands emitted by the data retrieval means.

The checking means 12 make it possible to provide security for the communication between the data collection module 10 and the device controller 20 as well as to obtain data relating to the device.

According to one embodiment, a set of authorized reading commands are stored in the data collection module 10. This set of authorized reading commands may be stored in the data collection module 10 for example at the time of the manufacture of the data collection module 10 or on installation of the data processing system 1 in the rail transport vehicle 100.

The checking means 12 are configured to check that the reading commands emitted by the data retrieval means 11 belong to the set of authorized reading commands so as to enable or refuse the emission of a reading command generated by the retrieval means, to the maintenance port 21 of the device controller 20.

In some embodiments, the checking means 12 are furthermore configured to monitor the frequency used in the communications between the data collection module 10 and the device controller 20, so as to enable or block communication according to the frequency used.

When the checking means 12 find that the frequency used in the exchanges between the data collection module 10 and the device controller 20 does not match a predefined frequency (this being even though it had been checked that the reading command belongs to the set of authorized reading commands), the checking means 12 prevent the communication between these two components.

In one embodiment, the checking means 12 are formed by a programmable component 120, for example of FPGA type. The programmable component may be programmed on manufacture of the data collection module 10, or reprogrammed later according to the device controller 20 to which it will be connected.

The programmable component 120 may thus be programmed to enable the sending of reading commands generated by the retrieval means 11 to the maintenance port 21 of the device controller 20 if the reading command is part of the set of authorized reading commands. The set of authorized reading commands may be stored within the programmable component 120 or in a memory apart in the checking means 12.

In the embodiment shown, the checking means 12 comprise switching means 121 disposed between the output from the retrieval means 11 and the connection means 13. The switching means 121 may have an open position in which the sending of a reading command generated by the checking means 11 to the maintenance port 21 of the device controller 20 is prevented, or a closed position in which the sending of a of a reading command generated by the checking means 11 to the maintenance port 21 of the device controller 20 is permitted.

In the embodiment shown, the programmable component 120 controls the opening and the closing of switching means 121 according to the result of checking the belonging of the generated reading command to the set of authorized reading commands.

As indicated previously, the data collection module 10 further comprises communication means 113 which are configured to send the data collected and stored in memory 112 to the data concentrator module 30.

The data concentrator module 30 may in certain embodiments comprise an input/output interface (not shown), for example a screen, a keyboard, a mouse or another pointing device such as a touch screen enabling an user to interact with the data collection system 1 on board the vehicle 100 via a graphical interface. This feature may in particular enable the driver in real time to view critical events or statuses detected by the modules (faults in safety devices such as the doors or the brakes, door closing status, inability to close a door due to an obstacle, insufficient level of sand no longer enabling a proper level of adhesion to the rail, etc. . . . ).

As indicated below, in some embodiments, the data concentrator module has capabilities for analysis of the data received from the data collection modules.

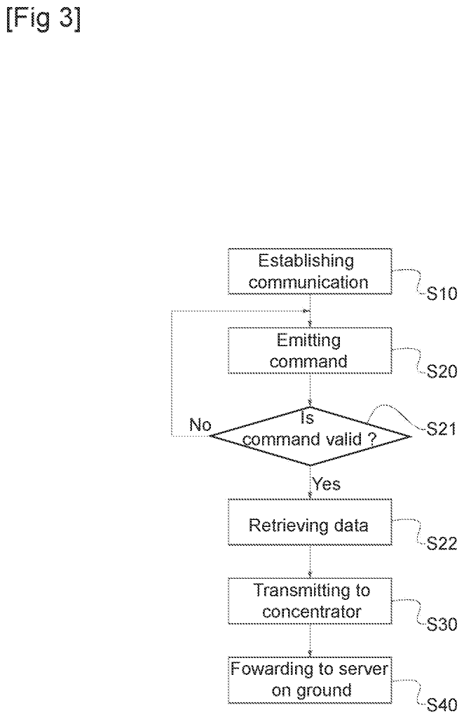

Steps of the method of data processing relating to at least one device on board a rail transport vehicle, according to one embodiment, are shown in FIG. 3.

When the data collection module 10 and the device controller 20 are linked together, a step S10 of establishing communication between the data collection module 10 and the device controller 20 is implemented. As indicated above, the communication is established through the maintenance port 21 of the device controller 20.

Next, the data retrieval means 11 implement a step S22 of retrieving data relating to the device during the operation of the device at predefined instants, via said communication established at step S10. For this, the retrieval means 11 emit a reading command at an emitting step S20. The checking means 12 check that this reading command is authorized at a checking step S21.

If at the data checking step S21, it is verified that the reading command is authorized, or for example that it belongs to the set of authorized reading commands, the data retrieval step S22 is carried out.

The data collected during the retrieval step S22 are next processed and transmitted, at a transmitting step S30, to the data concentrator module 30.

The data concentrator module 30 carries out a step S40 for forwarding the data received from said data concentrator module, to a server on the ground.

Thus, by virtue of the data collection system, a large amount of data relating to devices in a passenger transport vehicle may be retrieved so as to be able to check that the devices are operating correctly and act rapidly in case of malfunction. Furthermore, analyses on the behavior of the devices in the course of trips by the vehicle, as well as the behavior of the vehicle itself, may be carried out.

1. A data collection module for collecting data relating to at least one device of a vehicle, the data collection module comprising:
connection means configured to be connected to a maintenance port of a device controller that manages operation of the at least one device, the connection means configured to establish communication with the device controller through the maintenance port; and
data retrieval means configured to collect, during the operation of the at least one device at predefined instants, data relating to the at least one device via the communication that is established.

2. The data collection module of claim 1, wherein the data retrieval means are configured to emit commands for reading the data relating to the at least one device.

3. The data collection module of claim 2, further comprising:
checking means configured for checking authenticity of the commands.

4. The data collection module of claim 3, wherein the checking means comprise a programmable component.

5. The data collection module of claim 1, wherein the retrieval means are configured for the communication between the data collection module and the device controller, and to collect the data relating to the at least one device.

6. The data collection module of claim 1, wherein the data relating to the at least one device comprise one or more of first parameters for input to or for output from the device controller, second parameters determined by the device controller, or fault statuses determined by the device controller.

7. The data collection module of claim 1, further comprising:
transmission means configured to transmit the data that was collected to a data concentrator module.

8. A system for processing data relating to a set of the devices of a vehicle, the system comprising a set of the data collection module of claim 1, each of the data collection modules associated with a device controller that manages operation of at least one device of the set of devices.

9. The system of claim 8, further comprising:
a data concentrator module configured to receive data coming from the data collection modules of the set of modules.

10. The system of claim 9, wherein the data concentrator module is configured to transmit data to a server on the ground.

11. A vehicle comprising the system of claim 8.

12. A method of processing data relating to at least one device on board a vehicle, the method comprising:
establishing communication between a collection module for collecting data relating to the at least one device and a device controller managing operation of the at least one device, the communication being established through a maintenance port of the device controller; and
retrieving the data relating to the at least one device during the operation of the at least one device at predefined instants via the communication that is established.

13. The method of claim 12, further comprising:
emitting a command for reading the data relating to the at least one device;
and
checking the command that is emitted to check whether the command is authorized, wherein the data is retrieved responsive to the command being authorized.

14. The method of claim 12, further comprising:
transmitting the data that are collected to a data concentrator module.

15. The method of claim 14, further comprising:
forwarding the data received from the data concentrator module to a server on the ground.

16. The method of claim 12, wherein the vehicle is a passenger transport vehicle.

17. The data collection module of claim 1, wherein the vehicle is a passenger transport vehicle.

18. The system of claim 8, wherein the vehicle is a passenger transport vehicle.
